(19) United States
(12) Patent Application Publication
(10) Pub. No.: US 2026/0224429 A1
(43) Pub. Date: Aug. 6, 2026

(54) WEARABLE ROBOT WITH EMBEDDED CABLE

(71) Applicants: Hyundai Motor Company, Seoul (KR); Kia Corporation, Seoul (KR)

(72) Inventors: Taek Seong Jin, Hwaseong (KR); Hyun Seop Lim, Hwaseong (KR); Ju Young Yoon, Hwaseong (KR); Kyu Jung Kim, Hwaseong (KR); Kuk Hyun Ahn, Hwaseong (KR); Ho Jun Kim, Hwaseong (KR); Seung Jun Lee, Hwaseong (KR); Neung Hwan Yim, Hwaseong (KR); Dong Jin Hyun, Hwaseong (KR); Joo Won Lee, Hwaseong (KR)

(21) Appl. No.: 19/276,725

(22) Filed: Jul. 22, 2025

(30) Foreign Application Priority Data
Feb. 3, 2025 (KR) 10-2025-0013389

(51) Int. Cl. A61H 3/00; A61H 1/02; B25J 9/00; B25J 9/10

(52) U.S. Cl. CPC A61H 3/00; A61H 1/0262; B25J 9/0006; B25J 9/1045; A61H 2003/007; A61H 2201/0192; A61H 2201/14; A61H 2201/164; A61H 2201/165

(57) ABSTRACT

A wearable robot includes a waist support device configured to support a wearer's waist, a left leg support device coupled to a left side of the waist support device and configured to be mounted on the wearer's left leg, and a right leg support device coupled to a right side of the waist support device and configured to be mounted on the wearer's right leg, in which at least one of the waist support device, the left leg support device, or the right leg support device includes a length adjustment device configured to adjust a length thereof, in which the length adjustment device includes a body, a cover coupled to the body, a cable support device provided between the body and the cover, and a cable having two opposite fixed ends and at least partially supported on the cable support device.

### CROSS-REFERENCE TO RELATED APPLICATION

This application claims under 35 U.S.C. § 119(a) the benefit of Korean Patent Application No. 10-2025-0013389 filed in the Korean Intellectual Property Office on Feb. 3, 2025, the entire contents of which are incorporated herein by reference.

### BACKGROUND

### (a) Technical Field

The present disclosure relates to a wearable robot, more particularly, to the wearable robot in which a cable may be protected by being embedded in a length adjustment device.

### (b) Description of the Related Art

A wearable lower limb assistance robot, which is worn on a lower limb of a wearer and assists the wearer in walking, has a structure that assists a rotational force of a hip joint of the wearer and a rotational force of a knee joint. The wearable robot may be configured to adjust a length thereof to fit the wearer's body.

The wearable robot in the related art may have a structure in which a cable for adjusting a length is exposed to the outside, which causes a problem in that a likelihood of damage to the cable is increased, and user safety and reliability of devices are degraded.

### SUMMARY

The present disclosure provides a wearable robot capable of protecting a cable by being provided with a structure in which the cable is embedded in a length adjustment device and supported by a cable support device.

According to the present disclosure, a wearable robot includes: a waist support device configured to support a wearer's waist; a left leg support device coupled to a left side of the waist support device and configured to be mounted on the wearer's left leg; and a right leg support device coupled to a right side of the waist support device and configured to be mounted on the wearer's right leg, wherein at least one of the waist support device, the left leg support device, or the right leg support device comprises a length adjustment device configured to adjust a length thereof, wherein the length adjustment device comprises: a body; a cover coupled to the body; a cable support device provided between the body and the cover; and a cable having two opposite fixed ends and at least partially supported on the cable support device.

According to another aspect of the present disclosure, a wearable robot includes: a waist support device configured to support a wearer's waist; a left leg support device coupled to a left side of the waist support device and configured to be mounted on the wearer's left leg; and a right leg support device coupled to a right side of the waist support device and configured to be mounted on the wearer's right leg, in which at least one of the waist support device, the left leg support device, or the right leg support device includes a length adjustment device configured to adjust a length thereof, in which the length adjustment device includes: a body; a cover coupled to the body; a cable support device provided between the body and the cover; and a cable having two opposite fixed ends and at least partially supported on the cable support device, and in which the cable support device includes: a guide member coupled to the body and having a groove; a slider configured to slide along the groove of the guide member; a spring having one end fixed to the body and the other end fixed to the slider; and a plurality of fixing rollers rotatably coupled to the body and provided to be in contact with the cable.

In an embodiment, the length adjustment device provided in the waist support device may be a waist length adjustment device, the waist support device may include: a main body; a left coupling module coupled to a left side of the main body, configured to be movable in leftward and rightward directions, and configured such that the left leg support device is coupled to the left coupling module; and a right coupling module coupled to a right side of the main body, configured to be movable in the leftward and rightward directions, and configured such that the right leg support device is coupled to the right coupling module, the left coupling module and the right coupling module may each include: the waist length adjustment part; and a coupling device connected to one side of the waist length adjustment device and configured such that the left leg support device and the right leg support device are coupled to the coupling device, and the waist length adjustment device may have the other side movably coupled to the main body and be configured such that at least a device of the waist length adjustment device is extended from the main body or retracted into the main body to adjust a length of the waist support device.

In the embodiment, the waist support device may be provided such that the left coupling module and the right coupling module are vertically symmetric with respect to the main body.

In the embodiment, the waist length adjustment device may include: a first body movably coupled to the main body; a first cover coupled to a front side of the first body; a first cable support device provided between the first body and the first cover; and a waist cable supported by the first cable support device in a state in which two opposite ends of the waist cable are respectively fixed to the main body and the coupling device.

In the embodiment, the first cable support device may include: a first guide member coupled to the first body and having a groove extending in the leftward and rightward directions; a first slider slidably coupled to the first guide member; a first spring extending in the leftward and rightward directions and having one end coupled to the first body and the other end coupled to the first slider; and a first fixing roller coupled to the first body, provided to be in contact with the waist cable, and configured to rotate in response to a movement of the waist cable.

In the embodiment, the first slider may include: a first flange portion disposed between the first guide member and the first body; a first fixing protrusion extending from the first flange portion toward the first cover and having one side to which the first spring is coupled; and a first movable roller rotatably coupled to the first flange portion and spaced apart from the other side of the first fixing protrusion.

In the embodiment, the first cover may have a guide protrusion protruding from a surface facing the first body to form a groove corresponding to the groove of the first guide member.

In the embodiment, a first spring post, to which the first spring is fixed, may be provided on the first body, and the first spring may be configured to connect the first slider and the first spring post in the leftward and rightward directions and provide an elastic restoring force in response to a movement of the first slider relative to the first spring post.

In the embodiment, the waist cable may be provided to extend from one end fixed to the main body to the other end fixed to the coupling device while traversing a space between the first movable roller and the first fixing protrusion.

In the embodiment, the waist cable may extend from the main body toward the coupling device, be primarily bent toward the main body while surrounding the first movable roller, extend after being primarily bent, and be secondarily bent toward the coupling device while surrounding the first fixing roller.

In the embodiment, the left leg support device may include: a first left link module coupled to the left coupling module of the waist support part; a second left link module rotatably coupled to a lower end of the first left link module; and a third left link module rotatably coupled to a lower end of the second left link module, and the right leg support device may include: a first right link module coupled to the right coupling module of the waist support part; a second right link module rotatably coupled to a lower end of the first right link module; and a third right link module rotatably coupled to a lower end of the second right link module.

In the embodiment, the length adjustment device provided in each of the left leg support device and the right leg support device may be a leg length adjustment device, the second left link module and the second right link module may each include: a first sub-link module having an upper end to which the first left link module and the first right link module are rotatably connected; and a second sub-link module coupled to a lower end of the first sub-link module, and configured to be movable in upward and downward directions, and having a lower end to which the third left link module and the third right link module are rotatably connected, and the second sub-link module may include the leg length adjustment device.

In the embodiment, the first sub-link module may include: a first connection device connected to the first left link module and the first right link module; and an insertion device coupled to a lower end of the first connection device and configured such that the leg length adjustment device is inserted into the insertion device so as to be movable in the upward and downward directions, and the second sub-link module may further include a second connection device coupled to a lower end of the leg length adjustment device and configured such that the third left link module and the third right link module are connected to the second connection device.

In the embodiment, the leg length adjustment device may be configured to adjust a length of the second sub-link module while being extended from the insertion device or retracted into the insertion device.

In the embodiment, the leg length adjustment device may include: a second body movably coupled to the insertion part; a second cover coupled to one side of the second body; a second cable support device provided between the second body and the second cover; and a leg cable supported by the second cable support device in a state in which two opposite ends of the leg cable are respectively fixed to the first connection device and the second connection device.

In the embodiment, the second cable support device may include: a second guide member coupled to the second body and having a groove extending in the upward and downward directions; a second slider slidably coupled to the second guide member; a second spring extending in the upward and downward directions and having a lower end coupled to the second body and an upper end coupled to the second slider; and a third fixing roller coupled to the second body, provided to be in contact with the leg cable, and configured to rotate in response to a movement of the leg cable.

In the embodiment, the second slider may include: a second flange portion disposed between the second guide member and the second body; a second fixing protrusion extending from the second flange portion toward the second cover and having a lower side to which the second spring is coupled; and a second movable roller rotatably coupled to the second flange portion and spaced apart from an upper side of the second fixing protrusion.

In the embodiment, a second spring post, to which the second spring is fixed, may be provided on the second body, and the second spring may be configured to connect the second slider and the second spring post in the upward and downward directions and provide an elastic restoring force in response to a movement of the second slider relative to the second spring post.

In the embodiment, the leg cable may be provided to extend from a lower end fixed to the second connection device to an upper end fixed to the first connection device while traversing a space between the second movable roller and the second fixing protrusion.

In the embodiment, the leg cable may extend from the second connection device toward the first connection device, be primarily bent toward the second connection device while surrounding the third fixing roller, extend after being primarily bent, and be secondarily bent toward the first connection device while surrounding the second movable roller.

According to the embodiment of the present disclosure, it is possible to ensure the durability of the cable and the safety of the wearer by preventing the cable embedded in the length adjustment device of the wearable robot from being twisted, damaged by being bent, and disconnected.

### BRIEF DESCRIPTION OF THE DRAWINGS

FIG. 1 is a front perspective view of a wearable robot according to an embodiment of the present disclosure.

FIG. 2 is a rear perspective view of the wearable robot according to the embodiment of the present disclosure.

FIG. 3 is a view illustrating a waist support device of the wearable robot according to the embodiment of the present disclosure.

FIG. 4 is a view illustrating a length adjustment operation of the waist support device of the wearable robot according to the embodiment of the present disclosure.

FIG. 5 is a view illustrating a main body and a left coupling module of the waist support device according to the embodiment of the present disclosure.

FIG. 6 is a view illustrating a waist length adjustment device of the waist support device according to the embodiment of the present disclosure.

FIG. 7 is a view illustrating the waist length adjustment device of the waist support device according to the embodiment of the present disclosure.

FIG. 8 is a view illustrating an operation in which the waist support device according to the embodiment of the present disclosure switches between a minimum length state and a maximum length state.

FIG. 9 is a view illustrating the main body and the left coupling module when the waist support device according to the embodiment of the present disclosure is in the minimum length state.

FIG. 10 is a view illustrating the main body and the left coupling module when the waist support device according to the embodiment of the present disclosure is in the maximum length state.

FIG. 11 is a view illustrating a movement of a waist cable when the waist support device according to the embodiment of the present disclosure switches between the minimum length state and the maximum length state.

FIG. 12 is a view illustrating a left leg support device of the wearable robot according to the embodiment of the present disclosure.

FIG. 13 is a view illustrating a length adjustment operation of the left leg support device of the wearable robot according to the embodiment of the present disclosure.

FIG. 14 is a view illustrating a device of a first sub-link module and a device of a second sub-link module of the left leg support device according to the embodiment of the present disclosure.

FIG. 15 is a view illustrating a leg length adjustment device of the left leg support device according to the embodiment of the present disclosure.

FIG. 16 is an exploded view illustrating the leg length adjustment device of the left leg support device according to the embodiment of the present disclosure.

FIG. 17 is a view illustrating a second cable support device of the leg length adjustment device of the left leg support device according to the embodiment of the present disclosure.

FIG. 18 is a view illustrating an operation in which the left leg support device according to the embodiment of the present disclosure switches between a minimum length state and a maximum length state.

FIG. 19 is a view illustrating a movement of a leg cable when the left leg support device according to the embodiment of the present disclosure switches between the minimum length state and the maximum length state.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the embodiments of the present disclosure, a detailed description of related publicly-known configurations or functions will be omitted when it is determined that the detailed description obscures the understanding of the embodiments of the present disclosure.

In addition, the terms including ordinal numbers such as “first” and “second” used in the present specification may be used to describe various constituent elements, but the constituent elements should not be limited by the terms, and these terms are used only to distinguish one constituent element from another constituent element. For example, a first component may be named a second component, and similarly, the second component may also be named the first component, without departing from the scope of the present disclosure. The term “and/or” includes any and all combinations of a plurality of the related and listed items.

In addition, in the present specification, a forward/rearward direction, a leftward/rightward direction, and an upward/downward direction are defined for convenience of description and may be orthogonal to one another. The directions may be understood as being determined based on a wearer wearing a wearable robot in a state in which the wearable robot stands upright on the ground surface (i.e., a state in which a leg support device of the wearable robot extends perpendicularly to the ground surface).

In particular, a wearable robot according to the present disclosure is a robot worn on a lower body of the wearer to assist the wearer in walking. Therefore, a shape of the wearable robot before the wearer wears the wearable robot may be different from a shape of the wearable robot after the wearer wears the wearable robot. Therefore, for convenience of description, in the present specification, a configuration of the wearable robot will be described with reference to a state in which the wearer wears the wearable robot to suit the purpose of the wearable robot according to the present disclosure. Therefore, the wearer will be mentioned below in order to merely explain the wearable robot. It is noted that the wearer, who is a person, is not an element constituting the wearable robot according to the present disclosure.

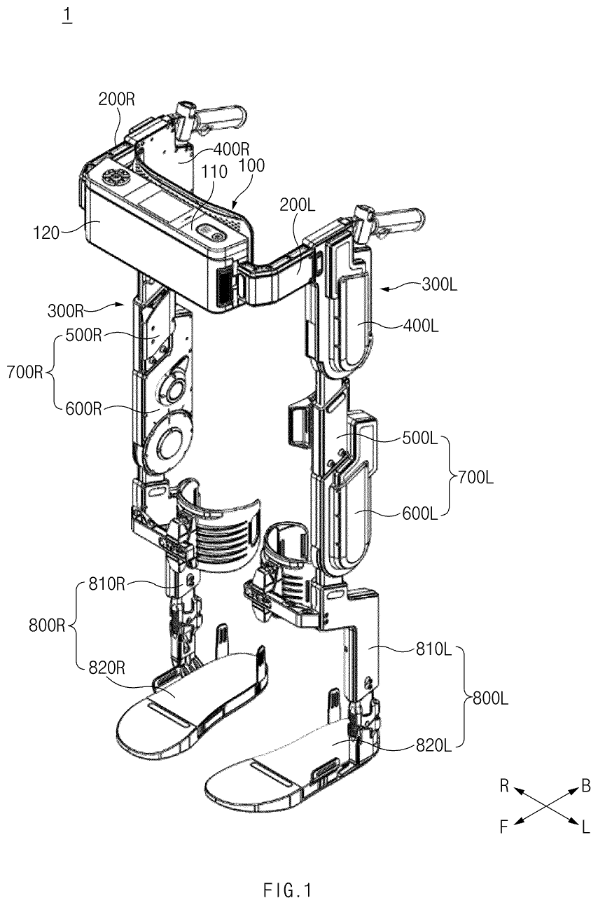

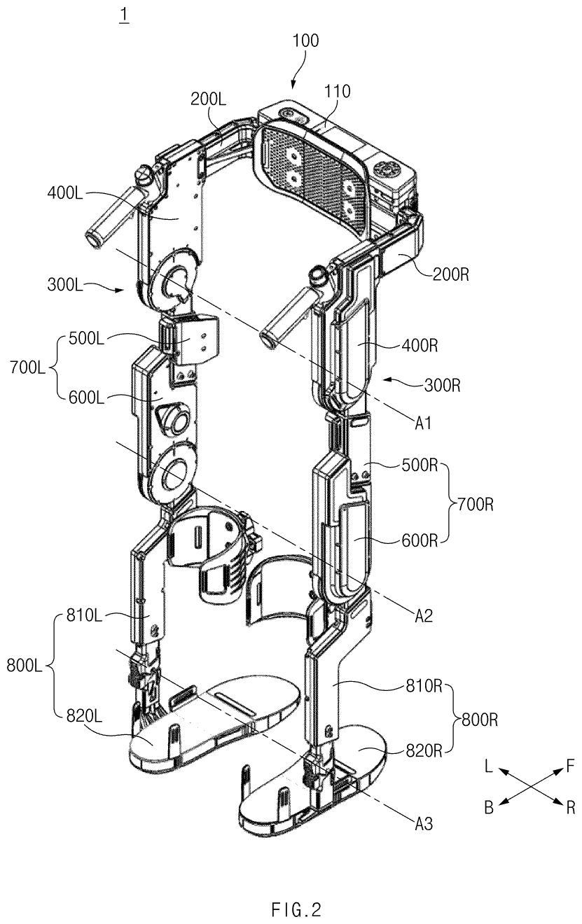

FIG. 1 is a front perspective view of a wearable robot according to an embodiment of the present disclosure. FIG. 2 is a rear perspective view of the wearable robot according to the embodiment of the present disclosure.

With reference to FIGS. 1 and 2, a wearable robot 1 according to the embodiment refers to a device worn on a lower body of the wearer. The wearable robot 1 may be a robot that assists the wearer in walking or moving when the wearer wears the wearable robot 1. For example, the wearable robot 1 is configured to at least partially rotate in forward and backward directions F and B about central axes in leftward and rightward directions L and R, such that the wearable robot 1 may assist and support rotations of joints of the lower body of the wearer that occur when the wearer walks or moves.

The wearable robot 1 according to the embodiment may include a waist support device 100, a left leg support device 300L connected to a left side L of the waist support device 100, and a right leg support device 300R connected to a right side R of the waist support device 100.

The waist support device 100 may be configured to support the wearer's waist. For example, the waist support device 100 may be configured to surround at least a device of the wearer's waist. The left leg support device 300L and the right leg support device 300R may be respectively coupled to the left side L and the right side R of the waist support device 100. For example, the waist support device 100 may include a main body 110, a left coupling module 200L connected to the left side L of the main body 110 and coupled to the left leg support device 300L, and a right coupling module 200R connected to the right side R of the main body 110 and coupled to the right leg support device 300R.

The left leg support device 300L may be configured to support the wearer's left leg. For example, the left leg support device 300L may be mounted or worn on the wearer's left leg and configured such that a lower end thereof is in contact with the ground surface.

The right leg support device 300R may be configured to support the wearer's right leg. For example, the right leg support device 300R may be mounted or worn on the wearer's right leg and configured such that a lower end thereof is in contact with the ground surface.

The left leg support device 300L and the right leg support device 300R may each include a plurality of link modules rotatably coupled to one another.

The left leg support device 300L may include a first left link module 400L coupled to the waist support device 100, a second left link module 700L coupled to the first left link module 400L and configured to be rotatable about a first rotation axis A1, and a third left link module 800L coupled to the second left link module 700L and configured to be rotatable about a second rotation axis A2. In this case, the first rotation axis A1 and the second rotation axis A2 may be parallel to each other in the leftward and rightward directions L and R and spaced apart from each other.

The second left link module 700L may include a first sub-link module 500L having an upper end rotatably coupled to the first left link module 400L, and a second sub-link module 600L having a lower end rotatably coupled to the third left link module 800L, and an upper end coupled to the first sub-link module 500L and configured to be movable in upward and downward directions (e.g., directions perpendicular to the leftward and rightward directions L and R and the forward and backward directions F and B).

The third left link module 800L may include a third sub-link module 810L having an upper end rotatably coupled to the second sub-link module 600L of the second left link module 700L, and a fourth sub-link module 820L coupled to a lower end of the third sub-link module 810L and configured to be rotatable about a third rotation axis A3. In this case, the third rotation axis A3 may be parallel to the first and second rotation axes A1 and A2.

The left leg support device 300L may be configured such that the first left link module 400L is disposed to face and support the wearer's left pelvis and/or left hip joint, the second left link module 700L is disposed to face and support the wearer's left femur, the third sub-link module 810L of the third left link module 800L is disposed to face and support the wearer's left lower leg, and the fourth sub-link module 820L of the third left link module 800L is disposed to face and support the wearer's left foot. The fourth sub-link module 820L of the left leg support device 300L may be provided to support the wearer's left sole and be in contact with the ground surface.

The right leg support device 300R may include constituent elements substantially identical to the those of the left leg support device 300L. The right leg support device 300R may be provided to be vertically symmetric with the left leg support device 300L based on the waist support device 100.

The right leg support device 300R may include a first right link module 400R coupled to the waist support device 100, a second right link module 700R coupled to the first right link module 400R and configured to be rotatable about the first rotation axis A1, and a third right link module 800R coupled to the second right link module 700R and configured to be rotatable about the second rotation axis A2. In this case, the first rotation axis A1 and the second rotation axis A2 may be parallel to each other in the leftward and rightward directions L and R and spaced apart from each other.

The second right link module 700R may include a first sub-link module 500R having an upper end rotatably coupled to the first right link module 400R, and a second sub-link module 600R having a lower end rotatably coupled to the third right link module 800R, and an upper end coupled to the first sub-link module 500R and configured to be movable in the upward and downward directions.

The third right link module 800R may include a third sub-link module 810R having an upper end rotatably coupled to the second sub-link module 600R of the second right link module 700R, and a fourth sub-link module 820R coupled to a lower end of the third sub-link module 810R and configured to be rotatable about the third rotation axis A3. In this case, the third rotation axis A3 may be parallel to the first and second rotation axes A1 and A2.

The right leg support device 300R may be configured such that the first right link module 400R is disposed to face and support the wearer's right pelvis and/or right hip joint, the second right link module 700R is disposed to face and support the wearer's right femur, the third sub-link module 810R of the third right link module 800R is disposed to face and support the wearer's right lower leg, and the fourth sub-link module 820R of the third right link module 800R is disposed to face and support the wearer's right foot. The fourth sub-link module 820R of the right leg support device 300R may be provided to support the wearer's right sole and be in contact with the ground surface.

The wearable robot 1 according to the embodiment may further include a power provider (not illustrated) configured to provide power for rotating the plurality of link modules provided in the left leg support device 300L and the right leg support device 300R. The power provider may be an electric motor.

Hereinafter, an operation in which the left leg support device 300L is rotated by power from the power provider will be described with reference to the left leg support device 300L as an example. The following description may also be applied to the right leg support device 300R in the same way.

For example, the power provider may provide power for rotating the second left link module 700L (particularly, the first sub-link module 500L of the second left link module 700L) about the first rotation axis A1 in the forward and backward directions F and B relative to the first left link module 400L. In addition, the power provider may provide power for rotating the third left link module 800L (particularly, the third sub-link module 810L of the third left link module 800L) about the second rotation axis A2 in the forward and backward directions F and B relative to the second left link module 700L (particularly, the second sub-link module 600L of the second left link module 700L).

In contrast, the fourth sub-link module 820L of the third left link module 800L may be provided as a link module having a passive shape and configured to be passively rotated while corresponding to a motion of the wearer's left ankle without receiving power from the power provider when rotating about the third rotation axis A3 relative to the third sub-link module 810L. However, this configuration is illustrative, and the fourth sub-link module 820L does not need to be necessarily provided in a passive shape. According to various embodiments, the fourth sub-link module 820L of the third left link module 800L may also be configured to be rotated by power transmitted from the power provider.

As described above, the first left link module 400L may extend from the wearer's left waist to the wearer's left hip joint, and the first right link module 400R may extend from the wearer's right waist to the wearer's right hip joint. In addition, the second left link module 700L may extend from the wearer's left hip joint to the wearer's left knee joint, and the second right link module 700R may extend from the wearer's right hip joint to the wearer's right knee joint. In addition, the third sub-link module 810L of the third left link module 800L may extend from the wearer's left knee joint to the wearer's left ankle joint, and the third sub-link module 810R of the third right link module 800R may extend from the wearer's right knee joint to the wearer's right ankle joint. In addition, the fourth sub-link module 820L of the third left link module 800L may extend from the wearer's left ankle joint to the wearer's left sole, and the fourth sub-link module 820R of the third right link module 800R may extend from the wearer's right ankle joint to the wearer's right sole.

The wearable robot 1 according to the present disclosure may be configured to adjust lengths of the waist support device 100 and the leg support parts 300L and 300R and have a structure in which a cable, which is embedded in a portion where the length is adjusted, is not exposed to the outside. Hereinafter, a length adjustment structure and a cable protection structure of the wearable robot 1 according to the present disclosure will be described.

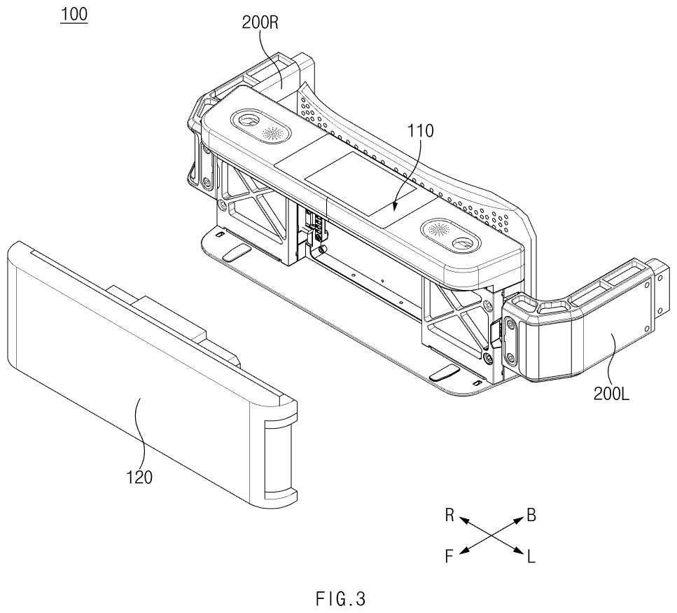

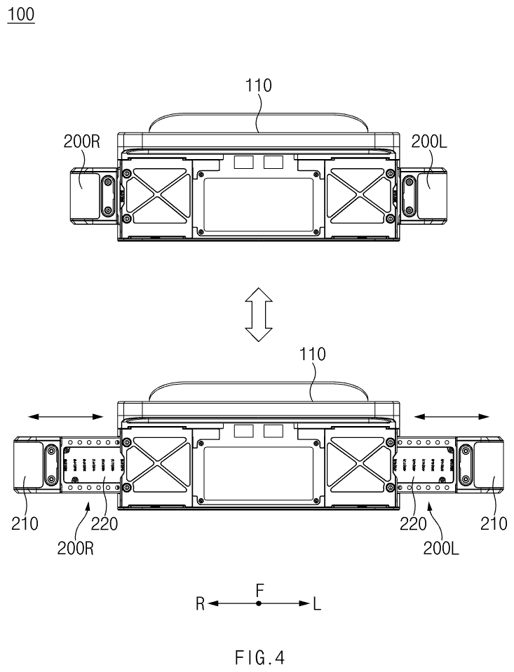

FIG. 3 is a view illustrating the waist support device of the wearable robot according to the embodiment of the present disclosure. FIG. 4 is a view illustrating a length adjustment operation of the waist support device of the wearable robot according to the embodiment of the present disclosure.

FIG. 3 illustrates a state in which the waist support device 100 in FIGS. 1 and 2 is disassembled into the main body 110 and a battery 120, and FIG. 4 illustrates an operation of adjusting a length of the waist support device 100 when a front surface of the waist support device 100, from which the battery 120 is separated, is viewed. For example, the upper view in FIG. 4 illustrates a state in which the waist support device 100 has a minimum length in the leftward and rightward directions L and R, and the lower view in FIG. 4 illustrates a state in which the waist support device 100 has a maximum length in the leftward and rightward directions L and R.

Hereinafter, the description related to FIGS. 3 and 4 will be described with reference to FIGS. 1 and 2, and a description of the components identical to those described above will be omitted.

With reference to FIGS. 3 and 4, the waist support device 100 of the wearable robot 1 according to the embodiment may include the main body 110, the battery 120 detachably coupled to a front side F of the main body 110, the left coupling module 200L movably coupled to the left side L of the main body 110 and coupled to the left leg support device (e.g., the left leg support device 300L in FIGS. 1 and 2), and the right coupling module 200R movably coupled to the right side R of the main body 110 and coupled to the right leg support device (e.g., the right leg support device 300R in FIGS. 1 and 2).

The battery 120 may be configured to supply electric power for driving and operating the wearable robot 1.

The left coupling module 200L may be coupled to the left side L of the main body 110 and configured to be movable in the leftward and rightward directions L and R. At least a device of the left coupling module 200L is extended from the main body 110 or retracted into the main body 110 while moving in the leftward and rightward directions L and R, such that the length of the waist support device 100 may be adjusted.

The left coupling module 200L may include a coupling device 210 to which the left leg support device 300L is coupled, and a waist length adjustment device 220 connected to the coupling device 210 and movably coupled to the main body 110. The waist length adjustment device 220 may be retracted into the main body 110 or extended from the main body 110 as the left coupling module 200L moves in the leftward and rightward directions L and R. That is, a left length of the waist support device 100 may be adjusted in accordance with a degree to which the waist length adjustment device 220 of the left coupling module 200L is extended from the main body 110.

The right coupling module 200R may include constituent elements substantially identical to those of the left coupling module 200L and be provided to be vertically symmetric with the left coupling module 200L based on the main body 110.

Similar to the left coupling module 200L, the right coupling module 200R may be coupled to the right side R of the main body 110 and configured to be movable in the leftward and rightward directions L and R. At least a device of the right coupling module 200R is extended from the main body 110 or retracted into the main body 110 while moving in the leftward and rightward directions L and R, such that the length of the waist support device 100 may be adjusted.

The right coupling module 200R may include the coupling device 210 to which the right leg support device 300R is coupled, and the waist length adjustment device 220 connected to the coupling device 210 and movably coupled to the main body 110. The waist length adjustment device 220 may be retracted into the main body 110 or extended from the main body 110 as the right coupling module 200R moves in the leftward and rightward directions L and R. That is, a right length of the waist support device 100 may be adjusted in accordance with a degree to which the waist length adjustment device 220 of the right coupling module 200R is extended from the main body 110.

The waist support device 100 may be configured such that the left coupling module 200L and the right coupling module 200R move independently of each other. That is, a degree to which the waist length adjustment device 220 of the left coupling module 200L is extended from the main body 110 and a degree to which the waist length adjustment device 220 of the right coupling module 200R is extended from the main body 110 may be adjusted to be different from each other.

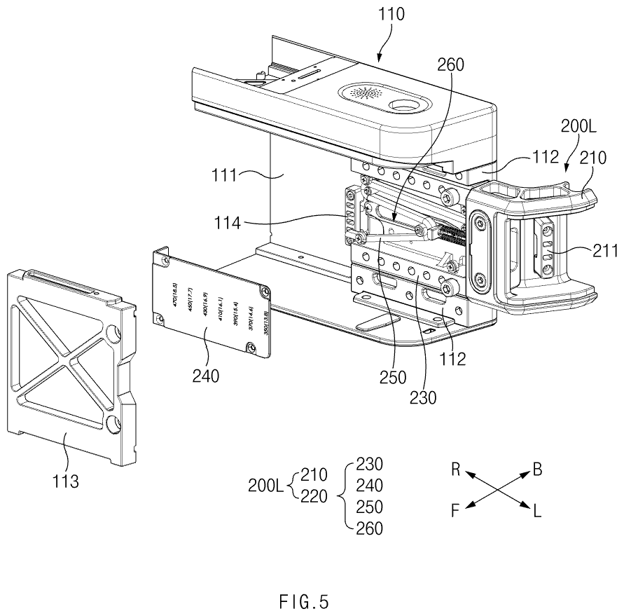

Hereinafter, constituent elements of the waist length adjustment device 220 will be described with reference to FIGS. 5 to 7.

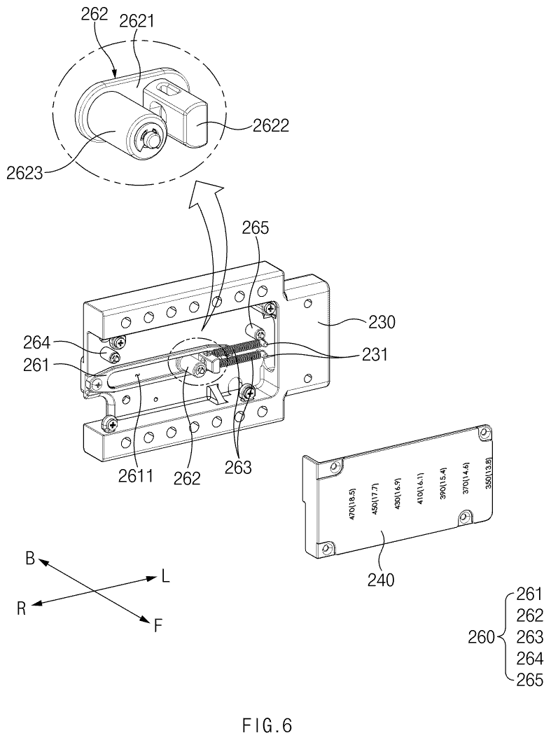

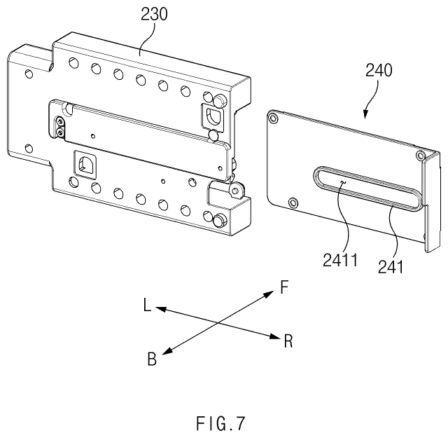

FIG. 5 is a view illustrating the main body and the left coupling module of the waist support device according to the embodiment of the present disclosure. FIG. 6 is a view illustrating the waist length adjustment device of the waist support device according to the embodiment of the present disclosure. FIG. 7 is a view illustrating the waist length adjustment device of the waist support device according to the embodiment of the present disclosure.

FIG. 5 illustrates a device of the main body 110 in which the left coupling module 200L is disposed in the waist support device 100 in FIG. 3 in a state in which the battery 120 is excluded. FIGS. 6 and 7 illustrate states of the waist length adjustment device 220 provided in the left coupling module 200L in FIG. 5 when viewed from the front and rear sides.

For convenience of description, FIGS. 5 to 7 illustrate the left coupling module 200L, and the waist length adjustment device 220 and a first cable support device 260 will be described below with reference to the left coupling module 200L. However, the left coupling module 200L and the right coupling module 200R are substantially identical in configuration and coupled to the main body 110 in substantially the same way. Therefore, the following description may also be applied to the right coupling module 200R in the same way.

With reference to FIGS. 5 to 7, the waist support device 100 according to the embodiment may include the main body 110, and the left coupling module 200L coupled to the left side of the main body 110 and configured to be movable in the leftward and rightward directions L and R.

The main body 110 may include a base device 111 having a rail 112 so that the waist length adjustment device 220 of the left coupling module 200L is movably inserted into the main body 110, and a rail cover 113 coupled to the base device 111 and configured to cover the rail 112. For example, the waist length adjustment device 220 may be inserted into a space between the rail 112 and the rail cover 113 so as to be movable in the leftward and rightward directions L and R. A first waist cable fixing device 114, to which one end of a waist cable 250 is fixed, may be provided on the base device 111.

The left coupling module 200L may include the waist length adjustment device 220 movably coupled to the main body 110, and the coupling device 210 connected to the left side L of the waist length adjustment device 220. A second waist cable fixing device 211, to which the other end of the waist cable 250 is fixed, may be provided on the coupling device 210. As described above, the coupling device 210 may be a constituent element to which the left leg support device (e.g., the left leg support device 300L in FIGS. 1 and 2) is coupled.

The waist length adjustment device 220 is extended from the main body 110 or retracted into the main body 110 while moving in the leftward and rightward directions L and R relative to the main body 110, such that a length between the coupling device 210 and the main body 110 in the leftward and rightward directions L and R may be increased or decreased.

The waist length adjustment device 220 may include a first body 230, a first cover 240, the waist cable 250, and the first cable support device 260.

The first body 230 may be movably coupled to the main body 110. For example, the first body 230 may be coupled to the rail 112 of the main body 110 and configured to be movable in the leftward and rightward directions L and R. The first body 230 may define an outer surface of a rear side of the waist length adjustment device 220.

The first cover 240 may be coupled to the front side F of the first body 230 and partially cover the first cable support device 260, which is provided on the first body 230, and the waist cable 250 supported on the first cable support device 260. The first cover 240 may define an outer surface of a front side of the waist length adjustment device 220.

The waist cable 250 may connect the main body 110 and the left coupling module 200L. At least a device of the waist cable 250 may be supported on the first cable support device 260 in a state in which one end of the waist cable 250 is fixed to the first waist cable fixing device 114 provided on the main body 110 and the other end of the waist cable 250 is fixed to the second waist cable fixing device 211 provided on the coupling device 210. For example, the waist cable 250 provided on the left coupling module 200L may have a left end fixed to the coupling device 210, and a right end fixed to the main body 110.

The waist cable 250 may be configured to move in response to the movement of the waist length adjustment device 220 when the length of the waist support device 100 is adjusted. For example, in case that the waist support device 100 is lengthened, the two opposite ends of the waist cable 250 fixed to the waist cable fixing parts 114 and 211 may move away from each other. In case that the waist support device 100 is shortened, the two opposite ends of the waist cable 250 fixed to the waist cable fixing parts 114 and 211 may move closer to each other. The above-mentioned movement of the waist cable 250 may be performed by the first cable support device 260.

The first cable support device 260 may be configured to support the waist cable 250 and guide the movement of the waist cable 250 when the waist length adjustment device 220 moves, thereby preventing the waist cable 250 from being twisted or damaged.

The first cable support device 260 may include a first guide member 261 coupled to a front surface of the first body 230 and having a groove 2611 extending in the leftward and rightward directions L and R, a first slider 262 slidably coupled to the first guide member 261, a first spring 263 extending in the leftward and rightward directions L and R and having one end coupled to the first body 230 and the other end coupled to the first slider 262, and a plurality of fixing rollers 264 and 265 provided to be in contact with the waist cable 250 and configured to rotate in response to the movement of the waist cable 250.

The first guide member 261 and the plurality of fixing rollers 264 and 265 may be coupled to the front surface of the first body 230. A first spring post 231, to which the first spring 263 is fixed, may be provided on the first body 230.

The first guide member 261 may be coupled to the front surface of the first body 230 so that the groove 2611 extends in the leftward and rightward directions L and R. A guide protrusion 241 may be provided on the first cover 240 to form a groove 2411 corresponding to the groove 2611 of the first guide member 261. For example, the guide protrusion 241 may protrude toward the first body 230 from a rear surface of the first cover 240.

The first slider 262 may be at least partially inserted into the groove 2611 of the first guide member 261 and move along the groove 2611.

The first slider 262 may include a first flange portion 2621 disposed between a rim portion of the first guide member 261 and the first body 230, a first fixing protrusion 2622 extending forward from the first flange portion 2621, and a first movable roller 2623 extending forward from the first flange portion 2621, disposed at a side opposite to one side of the first fixing protrusion 2622 directed toward the first spring 263, and spaced apart from the first fixing protrusion 2622. For example, the first movable roller 2623 may be disposed at the right side of the first fixing protrusion 2622, and the first spring 263 may be connected to the left side of the first fixing protrusion 2622. The first fixing protrusion 2622 and the first movable roller 2623 may be inserted into the groove 2611 and protrude forward from the first guide member 261. The waist cable 250 may be disposed in a space between the first fixing protrusion 2622 and the first movable roller 2623.

The first fixing protrusion 2622 and the first movable roller 2623 of the first slider 262 may be partially inserted into the groove 2411 formed by the guide protrusion 241 of the first cover 240 and be configured to move along the groove 2411 of the guide protrusion 241 together with the groove 2611 of the first guide member 261. That is, the movement of the first slider 262 may be doubly guided by the first guide member 261 and the guide protrusion 241. However, the guide protrusion 241 of the first cover 240 is not an essential component for the movement of the first slider 262 and may be excluded in accordance with various embodiments.

The first spring 263 may be configured to connect the first body 230 and the first slider 262 in the leftward and rightward directions L and R and provide an elastic force (or restoring force) in response to the movement of the first slider 262.

A left end of the first spring 263 may be coupled to the first spring post 231 of the first body 230 and relatively fixed, and a right end of the first spring 263 may be coupled to the first fixing protrusion 2622 of the first slider 262 and configured to relatively move. That is, as the first slider 262 moves leftward or rightward, the length of the first spring 263 based on the first spring post 231 may be increased or decreased.

The first spring 263 may be a tensile spring that generates a restoring force when stretched. Specifically, the left end of the first spring 263 is fixed to the first spring post 231, and the right end of the first spring 263 is coupled to the first slider 262 and configured to be movable in the leftward and rightward directions L and R. The first spring 263 may be stretched by a predetermined length when the first slider 262 moves toward the right side R, and the first spring 263 may be compressed again by the stretched length and restored to an original state when the first slider 262 moves toward the left side L. That is, in case that the first slider 262 moves toward the right side R, the first spring 263 may be stretched by a predetermined length and generate a restoring force that corresponds to the stretched length and is applied to pull the first slider 262 toward the left side L. When the waist length adjustment device 220 is moved by the restoring force of the first spring 263, the waist cable 250 may maintain a constant tension, which may prevent the waist cable 250 from being twisted. According to various embodiments, the first spring 263 may be modified to a rubber strap, a rubber band, or the like.

The plurality of fixing rollers 264 and 265 may be rotatably coupled to particular positions on the first body 230 and surrounded by the waist cable 250. When the waist length adjustment device 220 moves, the plurality of fixing rollers 264 and 265 may rotate so that the waist cable 250 moves.

The plurality of fixing rollers 264 and 265 may include a first fixing roller 264 provided above the right end of the first guide member 261, and a second fixing roller 265 provided above the left end of the first guide member 261. The first fixing roller 264 and the second fixing roller 265 may be provided such that the first movable roller 2623 of the first slider 262 is positioned between the first fixing roller 264 and the second fixing roller 265. For example, the first movable roller 2623 may be positioned at the left side of the first fixing roller 264 in a state in which the first slider 262 is moved to the right end of the groove 2611. The first movable roller 2623 may be positioned at the right side of the second fixing roller 265 in a state in which the first slider 262 is moved to the left end of the groove 2611. Meanwhile, the number and positions of the plurality of fixing rollers 264 and 265 provided on the first cable support device 260 are not specifically limited.

The waist cable 250 may be supported in a zigzag shape on the first cable support device 260. The waist cable 250 may be provided such that a direction in which the waist cable 250 extends while surrounding the first movable roller 2623 and the first fixing roller 264 is changed reversely.

As illustrated in FIG. 5, the waist cable 250 may extend leftward from the right end fixed to the main body 110 (e.g., the first waist cable fixing device 114), traverse between the first fixing protrusion 2622 and the first movable roller 2623, and extend rightward while surrounding the first movable roller 2623. The waist cable 250 extending rightward from the portion between the first fixing protrusion 2622 and the first movable roller 2623 extends leftward while surrounding the first fixing roller 264 and is supported on the second fixing roller 265. The waist cable 250 may extend while traversing the second fixing roller 265 so that the left end of the waist cable 250 is fixed to the coupling device 210 (e.g., the second waist cable fixing device 211).

That is, the waist cable 250 may extend leftward toward the first movable roller 2623 from the right end fixed to the main body 110, extend rightward to the first fixing roller 264 while surrounding the first movable roller 2623, and extend leftward again toward the second fixing roller 265 while surrounding the first fixing roller 264, and the waist cable 250 may be supported on the first cable support device 260 so that the left end of the waist cable 250 is fixed to the coupling device 210.

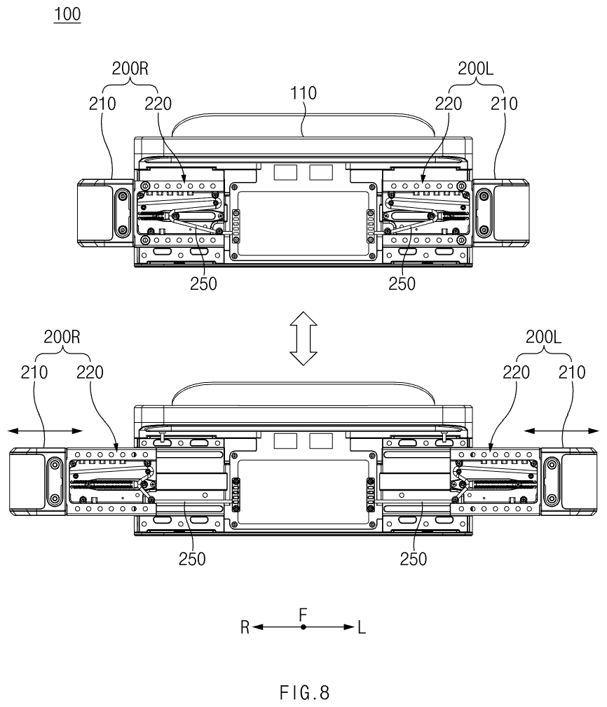

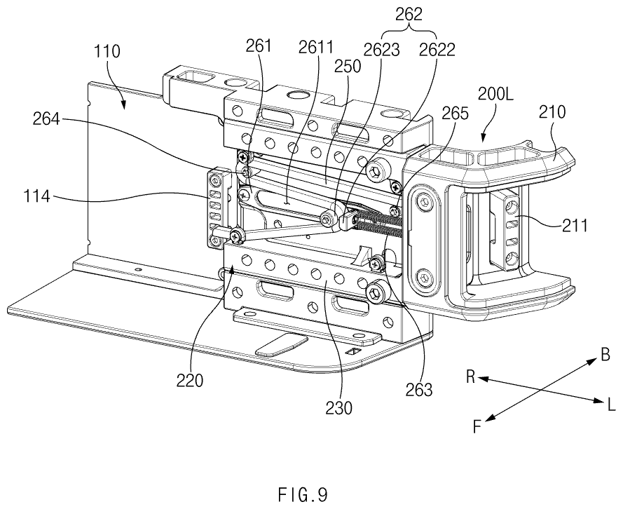

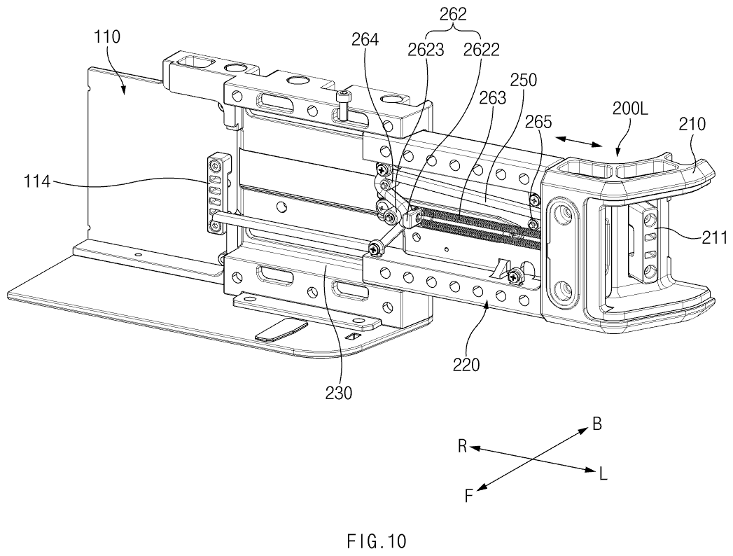

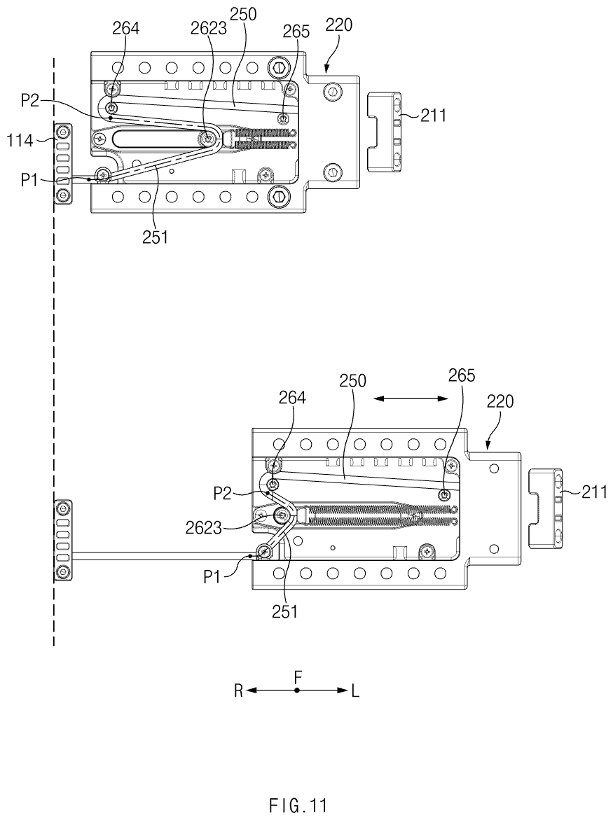

FIG. 8 is a view illustrating an operation in which the waist support device according to the embodiment of the present disclosure switches between a minimum length state and a maximum length state. FIG. 9 is a view illustrating the main body and the left coupling module when the waist support device according to the embodiment of the present disclosure is in the minimum length state. FIG. 10 is a view illustrating the main body and the left coupling module when the waist support device according to the embodiment of the present disclosure is in the maximum length state. FIG. 11 is a view illustrating a movement of the waist cable when the waist support device according to the embodiment of the present disclosure switches between the minimum length state and the maximum length state.

FIG. 8 is a view illustrating a state in which the rail cover 113 of the main body 110 and the first cover 240 of the waist length adjustment device 220 are excluded from the waist support device 100 illustrated in FIG. 4 so that the waist cable 250 is visible. FIGS. 9 and 10 are views illustrating states in which the first cover 240 is excluded from the waist length adjustment device 220 so that the waist cable 250 is visible. FIG. 10 is a view illustrating a state in which the cable fixing parts 114 and 211 and the waist cable 250 connected to the first cable support device 260 are separated in order to explain the movement of the waist cable 250.

FIGS. 8 to 11 are views for explaining the operation of adjusting the length of the waist support device 100 of the wearable robot 1 described above with reference to FIGS. 1 to 7. Hereinafter, a repeated description will be omitted.

For convenience of description, like FIGS. 5 to 7, FIGS. 9 to 11 illustrate the left coupling module 200L, and the operation of adjusting the length of the waist support device 100 will be described below with reference to the left coupling module 200L. However, the following description may also be applied to the right coupling module 200R in the same way.

Meanwhile, as described above, the description of the waist length adjustment device 220 and the first cable support device 260 described with reference to the left coupling module 200L and FIGS. 5 to 7 may also be applied to the right coupling module 200R in the same way. For example, with reference to FIG. 8, like the left coupling module 200L, the right coupling module 200R may also include the waist length adjustment device 220 and the coupling device 210, and the waist length adjustment device 220 of the right coupling module 200R may include the first body 230, the first cover 240, the waist cable 250, and the first cable support device 260.

However, as illustrated in FIG. 8, the right coupling module 200R is coupled to the main body 110 so as to be vertically symmetric with the left coupling module 200L. Therefore, it is understood that based on the description of the left coupling module 200L, the right coupling module 200R and the left coupling module 200L are reversed leftward and rightward. For example, the waist cable 250 of the right coupling module 200R may extend rightward toward the first movable roller 2623 from the left end fixed to the main body 110, extend leftward to the first fixing roller 264 while surrounding the first movable roller 2623, and extend rightward again toward the second fixing roller 265 while surrounding the first fixing roller 264, and the waist cable 250 may be supported on the first cable support device 260 so that the right end of the waist cable 250 is fixed to the coupling device 210.

With reference to FIGS. 8 to 11, the length in the leftward and rightward directions L and R of the waist support device 100 of the wearable robot 1 according to the embodiment may be adjusted as the left coupling module 200L and the right coupling module 200R move in the leftward and rightward directions L and R relative to the main body 110. In this case, the waist cable 250 may move in response to the movement of the waist length adjustment device 220 in the state in which at least a device of the waist cable 250 is supported on the first cable support device 260 of the waist length adjustment device 220.

When the left coupling module 200L is pulled leftward when the waist support device 100 is in the minimum length state, the waist length adjustment device 220 is extended from the main body 110, such that the waist support device 100 may switch to the maximum length state. In this case, the waist cable 250 is pulled in the leftward and rightward directions L and R as the coupling device 210 moves from the main body 110 toward the left side L in the state in which the two opposite ends of the waist cable 250 are fixed to the main body 110 and the coupling device 210. That is, the waist cable 250 is unfolded in the leftward and rightward directions L and R as the left end of the waist cable 250 moves leftward based on the right end of the waist cable 250 fixed to the main body 110.

A device of the waist cable 250, which is curved in a zigzag shape, is unfolded as the two opposite ends of the waist cable 250 are pulled in the leftward and rightward directions L and R, such that the first slider 262 moves rightward along the groove 2611, and the first spring 263 is stretched from the original state and generates a restoring force for pulling the first slider 262 leftward. For example, the first slider 262 is positioned at the left end of the groove 2611 when the waist support device 100 is in the minimum length state, and the first slider 262 moves rightward and is positioned at the right end of the groove 2611 when the waist support device 100 is in the maximum length state.

As the first slider 262 moves rightward, a distance between the first slider 262 and the first spring post 231 is increased, and the first spring 263 is stretched. The first spring 263 may be stretched and generate a restoring force proportional to the stretched length, thereby providing a constant tension to the waist cable 250. Therefore, it is possible to prevent the waist cable 250 from being twisted, bent, and disconnected when the length is adjusted.

On the contrary, when the left coupling module 200L is pulled rightward when the waist support device 100 is in the maximum length state, the waist length adjustment device 220 is retracted into the main body 110, such that the waist support device 100 may switch to the minimum length state. In this case, as the first slider 262 is moved leftward along the groove 2611 by a restoring force of the first spring 263, the waist cable 250 is pulled in the direction in which the two opposite ends of the waist cable 250 move toward each other. That is, the left end of the waist cable 250 moves rightward based on the right end of the waist cable 250 fixed to the main body 110, such that a device of the waist cable 250, which has been unfolded as the first slider 262 has moved rightward, is curved again.

As illustrated in FIG. 11, as the waist length adjustment device 220 moves in the leftward and rightward directions L and R relative to the main body 110, a length of a first bending section 251 of the waist cable 250, which is bent based on the first movable roller 2623 and has portions facing each other in the upward and downward directions, is changed.

In this case, the first bending section 251 may be defined as a section extending from the right end of the waist cable 250, traversing the first movable roller 2623 from a first point P1 overlapping the first body 230, and extending to a second point P2 being in contact with the first fixing roller 264.

When the waist support device 100 is in the minimum length state, the first slider 262 is positioned at the left end of the groove 2611, and the first movable roller 2623 is spaced apart leftward from the first cable fixing device 114 or the first fixing roller 264 at a maximum distance, such that the first bending section 251 may have a maximum length. On the contrary, when the waist support device 100 is in the maximum length state, the first slider 262 is positioned at the right end of the groove 2611, and the first movable roller 2623 is spaced apart leftward from the first cable fixing device 114 or the first fixing roller 264 at a minimum distance, such that the first bending section 251 may have a minimum length.

When a length of the first bending section 251 in the minimum length state of the waist support device 100 is referred to as a first length and a length of the first bending section 251 in the maximum length state of the waist support device 100 is referred to as a second length shorter than the first length, a length by which the waist cable 250 moves between the minimum length state and the maximum length state may be a difference between the first length and the second length.

For example, the waist support device 100 may be configured such that the first length is about 91 mm and the second length is about 29 mm. In this case, the waist cable 250 moves by about 62 mm to adjust the length of the waist support device 100. However, the above-mentioned numerical values are illustrative and do not limit the embodiment of the present disclosure.

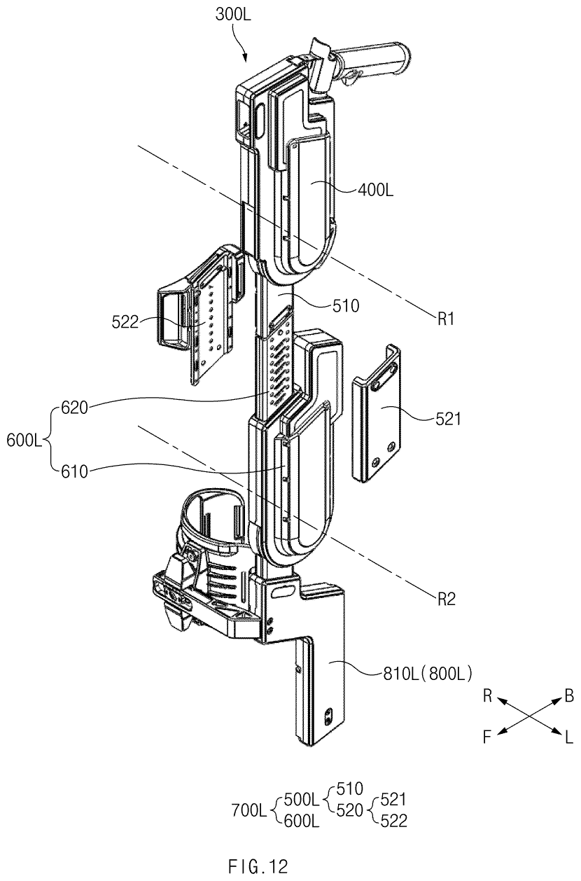

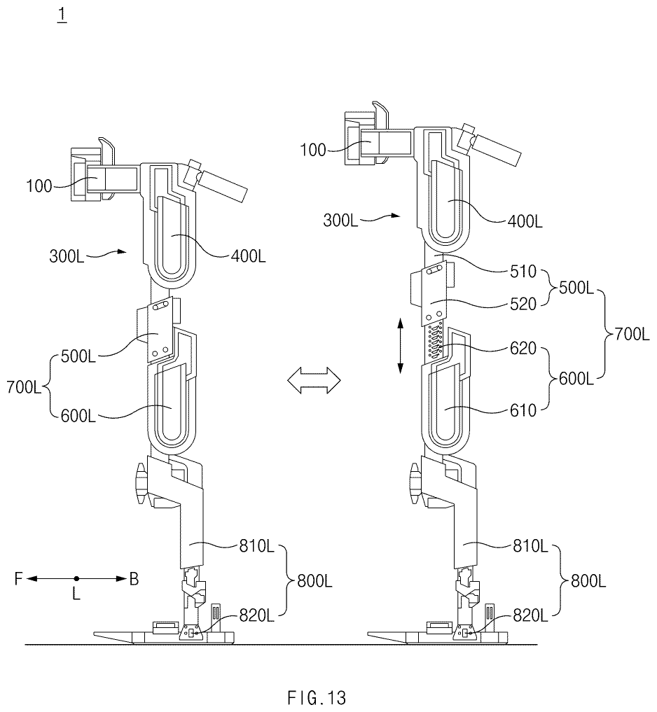

FIG. 12 is a view illustrating the left leg support device of the wearable robot according to the embodiment of the present disclosure. FIG. 13 is a view illustrating a length adjustment operation of the left leg support device of the wearable robot according to the embodiment of the present disclosure.

FIG. 12 illustrates a state in which the fourth sub-link module 820L of the third left link module 800L is excluded from the left leg support device 300L in FIGS. 1 and 2, and FIG. 13 illustrates an operation of adjusting a length of the left leg support device 300L in a state in which the left side L of the wearable robot 1 in FIGS. 1 and 2 is viewed from the front side. For example, the left view in FIG. 13 illustrates a state in which the left leg support device 300L has a minimum length in the upward and downward directions, and the right view in FIG. 13 illustrates a state in which the left leg support device 300L has a maximum length in the upward and downward directions.

Hereinafter, the description related to FIGS. 12 and 13 will be described with reference to FIGS. 1 and 2, and a description of the components identical to those described above will be omitted. In addition, for convenience of description, FIGS. 12 and 13 illustrate the left leg support device 300L, and the description will be described below with reference to the left leg support device 300L. However, because the left leg support device 300L and the right leg support device 300R are substantially identical in configuration, the following description may also be applied to the right leg support device 300R in the same way.

With reference to FIGS. 12 and 13, the left leg support device 300L of the wearable robot 1 according to the embodiment may include the first left link module 400L coupled to the waist support device 100, the second left link module 700L coupled to the lower end of the first left link module 400L and configured to be rotatable about the first rotation axis A1, and the third left link module 800L coupled to the lower end of the second left link module 700L and configured to be rotatable about the second rotation axis A2.

The second left link module 700L may include the first sub-link module 500L coupled to the first left link module 400L, and the second sub-link module 600L coupled to the first sub-link module 500L and configured to be movable in the upward and downward directions.

The length of the second left link module 700L may be adjusted as the first sub-link module 500L moves in the upward and downward directions relative to the second sub-link module 600L. For example, at least a device of the second sub-link module 600L is extended from the first sub-link module 500L or retracted into the first sub-link module 500L while moving in the upward and downward directions relative to the first sub-link module 500L, such that the length of the second left link module 700L may be adjusted. That is, the length of the left leg support device 300L in the upward and downward directions may be adjusted as the length of the second left link module 700L is adjusted.

The first sub-link module 500L may include a first connection device 510 to which a lower end of the first left link module 400L is rotatably connected, and an insertion device 520 coupled to a lower end of the first connection device 510 and configured such that at least a device of the second sub-link module 600L is movably inserted into the insertion device 520.

The insertion device 520 may be fixedly coupled to a lower end of the first connection device 510 and have therein a space into which a leg length adjustment device 620 of the second sub-link module 600L may be inserted. The insertion device 520 may include a first casing 521 coupled to the left side L of the first connection device 510, and a second casing 522 coupled to the right side R of the first connection device 510 and configured to face the first casing 521. For example, the first casing 521 and the second casing 522 are coupled to face each other, such that the insertion device 520 may have therein the space from or into which the leg length adjustment device 620 is extended or retracted.

The second sub-link module 600L may include a second connection device 610 to which the third left link module 800L is rotatably connected, and the leg length adjustment device 620 coupled to an upper end of the second connection device 610 and movably coupled to the insertion device 520.

The leg length adjustment device 620 may be retracted into the insertion device 520 or extended from the insertion device 520 as the first sub-link module 500L moves in the upward and downward directions relative to the second sub-link module 600L. That is, the length of the second left link module 700L may be adjusted in accordance with a degree to which the leg length adjustment device 620 is extended from the insertion device 520, and the length of the left leg support device 300L may be adjusted in accordance with the adjustment of the length of the second left link module 700L.

For example, as illustrated in FIG. 12, when the left leg support device 300L has a minimum length, the leg length adjustment device 620 may be completely inserted into the insertion device 520 of the first sub-link module 500L. In addition, when the left leg support device 300L has a maximum length, the leg length adjustment device 620 may be maximally extended from the insertion device 520 of the first sub-link module 500L.

With reference to FIGS. 1 and 2 together, the right leg support device 300R may include the first right link module 400R, the second right link module 700R, and the third right link module 800R. The second right link module 700R may include the first sub-link module 500R and the second sub-link module 600R configured to be movable in the upward and downward directions relative to each other. In addition, like the second left link module 700L of the left leg support device 300L, the second right link module 700R may also be configured such that the first sub-link module 500R includes a first connection device (not illustrated) and an insertion device (not illustrated), and the second sub-link module 600R includes a second connection device (not illustrated) and a leg length adjustment device (not illustrated).

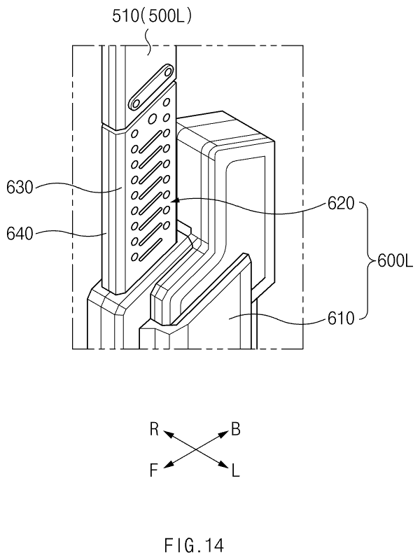

Hereinafter, constituent elements of the leg length adjustment device 620 will be described below with reference to FIGS. 14 to 17.

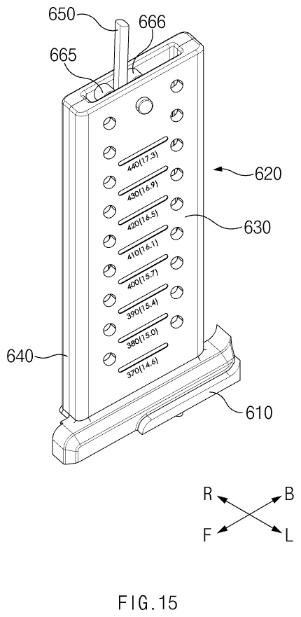

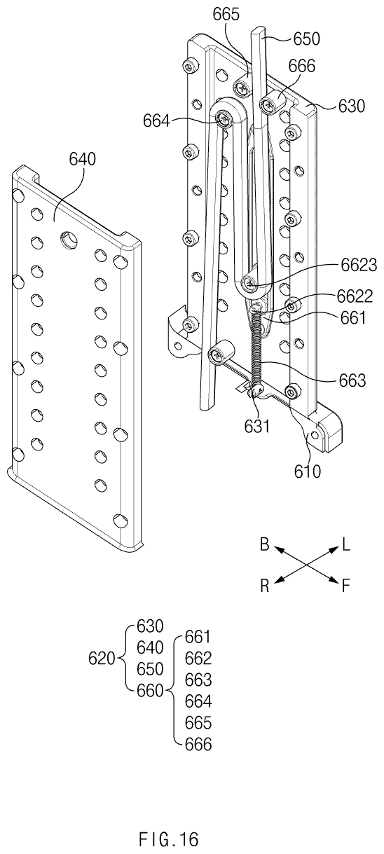

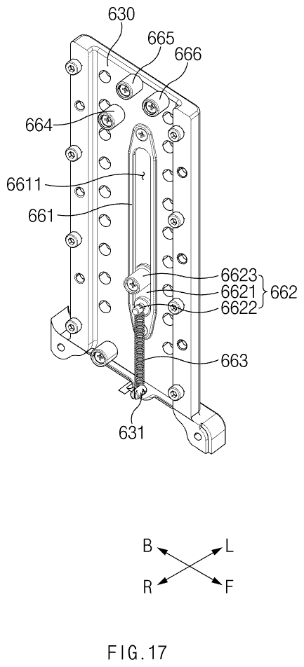

FIG. 14 is a view illustrating a device of the first sub-link module and a device of the second sub-link module of the left leg support device according to the embodiment of the present disclosure. FIG. 15 is a view illustrating the leg length adjustment device of the left leg support device according to the embodiment of the present disclosure. FIG. 16 is an exploded view illustrating the leg length adjustment device of the left leg support device according to the embodiment of the present disclosure. FIG. 17 is a view illustrating a second cable support device of the leg length adjustment device of the left leg support device according to the embodiment of the present disclosure.

FIGS. 14 and 15 illustrate the first sub-link module 500L and the left side L of the leg length adjustment device 620 included in the left leg support device 300L in FIG. 12. FIGS. 16 and 17 illustrate the right side R of the leg length adjustment device 620 of the left leg support device 300L in FIG. 12. FIG. 14 is a view illustrating an arrangement relationship between the first connection device 510 and the leg length adjustment device 620 in a state in which the insertion device 520 of the first sub-link module 500L is excluded.

As described above, for convenience of description, FIGS. 14 to 17 illustrate the left leg support device 300L, and the leg length adjustment device 620 and a second cable support device 660 will be described below with reference to the left leg support device 300L. However, the following description may also be applied to the right leg support device 300R in the same way.

With reference to FIGS. 14 to 17, the left leg support device 300L according to the embodiment may include the second sub-link module 600L configured to be movable in the upward and downward directions relative to the first sub-link module 500L, and the second sub-link module 600L may include the second connection device 610, and the leg length adjustment device 620 provided at the upper end of the second connection device 610. The first connection device 510 of the first sub-link module 500L may be positioned at the upper end of the leg length adjustment device 620 in a state in which the first connection device 510 is separated from the leg length adjustment device 620.

The leg length adjustment device 620 may be fixedly coupled to the second connection device 610. For example, at least a device of the leg length adjustment device 620 may extend upward from the second connection device 610 and be integrated with the second connection device 610.

The leg length adjustment device 620 may include a second body 630, a second cover 640, a leg cable 650, and the second cable support device 660. Meanwhile, the leg length adjustment device 620 may be a constituent element similar to the waist length adjustment device 220 of the waist support device 100 described with reference to FIGS. 5 to 11 and operate by substantially the same mechanism as the waist length adjustment device 220.

The second body 630 may be fixedly coupled to the second connection device 610. For example, the second body 630 may extend upward from the second connection device 610. The second body 630 may define a left outer surface of the leg length adjustment device 620 provided in the left leg support device 300L.

The second cover 640 may be coupled to the right side R of the second body 630 and partially cover the second cable support device 660, which is provided on the second body 630, and the leg cable 650 supported on the second cable support device 660. The second cover 640 may define a right outer surface of the leg length adjustment device 620 provided in the left leg support device 300L.

The leg cable 650 may connect the first sub-link module 500L and the second sub-link module 600L. At least a device of the leg cable 650 may be supported on the second cable support device 660 in a state in which one end of the leg cable 650 is fixed to the first connection device 510 of the first sub-link module 500L and the other end of the leg cable 650 is fixed to the second connection device 610 or the leg length adjustment device 620 of the second sub-link module 600L. For example, an upper end of the leg cable 650 may be fixed in the first connection device 510, a lower end of the leg cable 650 may be fixed in the second connection device 610, and cable fixing parts (not illustrated) may be provided on the first connection device 510 and the second connection device 610. However, according to various embodiments, the lower end of the leg cable 650 may be fixed to the second body 630 of the leg length adjustment device 620.

The leg cable 650 may be configured to move in response to the movement of the leg length adjustment device 620 when the length of the left leg support device 300L is adjusted. For example, in case that the second left link module 700L is lengthened, the two opposite ends of the leg cable 650 respectively fixed to the first sub-link module 500L and the second sub-link module 600L may move away from each other. In case that the second left link module 700L is shortened, the two opposite ends of the leg cable 650 respectively fixed to the first sub-link module 500L and the second sub-link module 600L may move closer to each other. The above-mentioned movement of the leg cable 650 may be performed by the second cable support device 660.

The second cable support device 660 may be configured to support the leg cable 650 and guide the movement of the leg cable 650 when the leg length adjustment device 620 moves, thereby preventing the leg cable 650 from being twisted or damaged.

The second cable support device 660 may include a second guide member 661 coupled to a right surface of the second body 630 and having a groove 6611 extending in the upward and downward directions, a second slider 662 slidably coupled to the second guide member 661, a second spring 663 extending in the upward and downward directions and having a lower end coupled to the second body 630 and an upper end coupled to the second slider 662, and a plurality of fixing rollers 664, 665, and 666 provided to be in contact with the leg cable 650 and configured to rotate in response to the movement of the leg cable 650.

The second guide member 661 and the plurality of fixing rollers 664, 665, and 666 may be coupled to the right surface of the second body 630. A second spring post 631, to which the second spring 663 is fixed, may be provided on the second body 630.

The second guide member 661 may be coupled to the right surface of the second body 630 so that the groove 6611 extends in the upward and downward directions. The second slider 662 may be at least partially inserted into the groove 6611 of the second guide member 661 and move along the groove 6611.

The second slider 662 may include a second flange portion 6621 disposed between a rim portion of the second guide member 661 and the second body 630, a second fixing protrusion 6622 extending rightward from the second flange portion 6621, and a second movable roller 6623 extending rightward from the second flange portion 6621, disposed at a side opposite to one side of the second fixing protrusion 6622 directed toward the second spring 663, and spaced apart from the second fixing protrusion 6622. For example, the second movable roller 6623 may be disposed at the upper side of the second fixing protrusion 6622, and the second spring 663 may be connected to the lower side of the second fixing protrusion 6622. The second fixing protrusion 6622 and the second movable roller 6623 may be inserted into the groove 6611 and protrude rightward from the second guide member 661. The leg cable 650 may be disposed in a space between the second fixing protrusion 6622 and the second movable roller 6623.

A lower end of the second spring 663 may be coupled to the second spring post 631 of the second body 630 and relatively fixed, and an upper end of the second spring 663 may be coupled to the second fixing protrusion 6622 of the second slider 662 and configured to relatively move. That is, as the second slider 662 moves upward or downward, the length of the second spring 663 based on the second spring post 631 may be increased or decreased.

The second spring 663 may be a tensile spring that generates a restoring force when stretched. Specifically, the lower end of the second spring 663 is fixed to the second spring post 631, and the upper end of the second spring 663 is coupled to the second slider 662 and configured to be movable in the upward and downward directions. The second spring 663 may be stretched by a predetermined length when the second slider 662 moves upward, and the second spring 663 may be compressed again by the stretched length and restored to an original state when the second slider 662 moves downward. That is, in case that the second slider 662 moves upward, the second spring 663 may be stretched by a predetermined length and generate a restoring force that corresponds to the stretched length and is applied to pull the second slider 662 downward. When the leg length adjustment device 620 is moved by the restoring force of the second spring 663, the leg cable 650 may maintain a constant tension, which may prevent the leg cable 650 from being twisted. According to various embodiments, the second spring 663 may be modified to a rubber strap, a rubber band, or the like.

The plurality of fixing rollers 664, 665, and 666 may be rotatably coupled to particular positions on the second body 630 and surrounded by the leg cable 650. When the leg length adjustment device 620 moves, the plurality of fixing rollers 664, 665, and 666 may rotate so that the leg cable 650 moves.

The plurality of fixing rollers 664, 665, and 666 may include a third fixing roller 664 provided rearward of an upper side of the second guide member 661, a fourth fixing roller 665 provided forward of the upper side of the second guide member 661, and a fifth fixing roller 666 disposed to face the fourth fixing roller 665. Meanwhile, the number and positions of the plurality of fixing rollers 664, 665, and 666 provided on the second cable support device 660 are not specifically limited.

The leg cable 650 may be supported in a zigzag shape on the second cable support device 660. The leg cable 650 may be provided such that a direction in which the leg cable 650 extends while surrounding the second movable roller 6623 and the third fixing roller 664 is changed reversely.

As illustrated in FIG. 16, the leg cable 650 may extend upward from the lower end fixed to the second sub-link module 600L (e.g., the second connection device 610 or the second main body 110), extend downward while surrounding the third fixing roller 664, traverse between the second fixing protrusion 6622 and the second movable roller 6623, and extend upward while surrounding the second movable roller 6623. The leg cable 650 extending upward from the portion between the second fixing protrusion 6622 and the second movable roller 6623 may extend upward while traversing between the fourth fixing roller 665 and the fifth fixing roller 666 so that the upper end of the leg cable 650 is fixed to the first connection device 510.

That is, the leg cable 650 may extend upward toward the third fixing roller 664 from the lower end fixed to the second sub-link module 600L, extend downward to the second movable roller 6623 while surrounding the third fixing roller 664, and extend upward again toward the fourth and fifth fixing rollers 665 and 666 while surrounding the second movable roller 6623, and the leg cable 650 may be supported on the second cable support device 660 so that the upper end of the leg cable 650 is fixed to the first connection device 510 of the first sub-link module 500L.

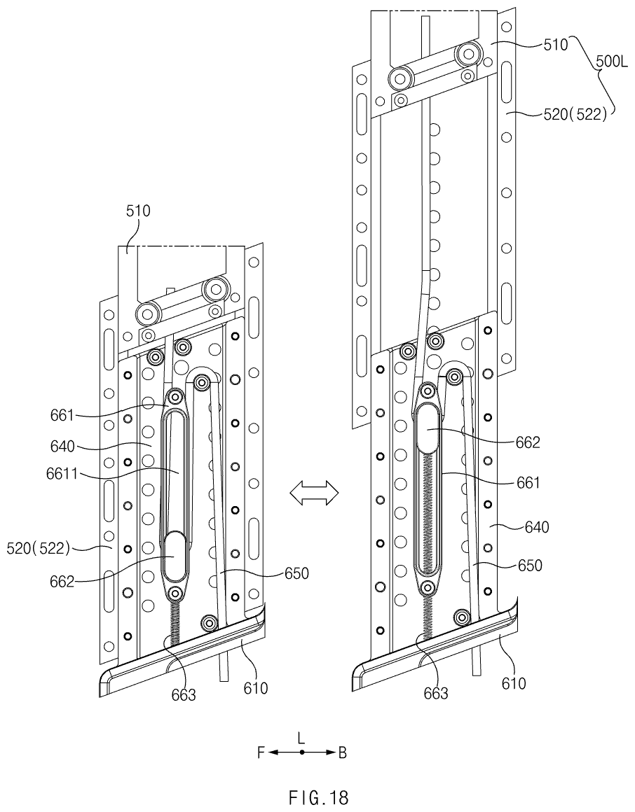

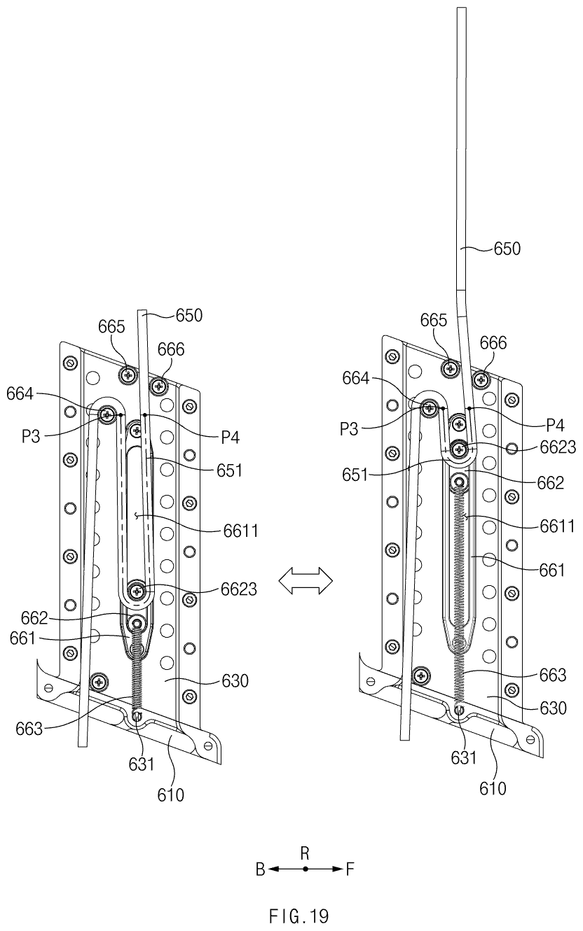

FIG. 18 illustrates an operation in which the left leg support device according to the embodiment of the present disclosure switches between a minimum length state and a maximum length state. FIG. 19 is a view illustrating a movement of the leg cable when the left leg support device according to the embodiment of the present disclosure switches between the minimum length state and the maximum length state.

FIG. 18 is an enlarged view illustrating the second left link module 700L of the left leg support device 300L illustrated in FIG. 13. FIG. 18 is a view illustrating a state in which the first casing 521 of the first sub-link module 500L and the second body 630 of the leg length adjustment device 620 are excluded from the second left link module 700L illustrated in FIG. 13 so that the leg cable 650 is visible. FIG. 19 is a view illustrating a state in which the right side of the second body 630 is viewed from the front side, and the second cover 640 is excluded from the leg length adjustment device 620 illustrated in FIG. 16 in order to explain the movement of the leg cable 650.

For convenience of description, like FIGS. 12 to 17, FIGS. 18 and 19 illustrate the second left link module 700L, and the operation of adjusting the length of the left leg support device 300L will be described below with reference to the second left link module 700L. However, the following description may also be applied to the right leg support device 300R in the same way.

With reference to FIGS. 18 and 19, the length in the upward and downward directions of the left leg support device 300L (particularly, the second left link module 700L) of the wearable robot 1 according to the embodiment may be adjusted as the first sub-link module 500L moves in the upward and downward directions relative to the second sub-link module 600L. In this case, the leg cable 650 may move in response to the movement of the leg length adjustment device 620 relative to the first sub-link module 500L in the state in which at least a device of the leg cable 650 is supported on the second cable support device 660 of the leg length adjustment device 620.

When the first sub-link module 500L is pulled upward relative to the second sub-link module 600L (or the second sub-link module 600L is pulled downward relative to the first sub-link module 500L) when the left leg support device 300L is in the minimum length state, the leg length adjustment device 620 is extended from the insertion device 520 of the first sub-link module 500L, such that the left leg support device 300L may switch to the maximum length state. In this case, the waist cable 250 is pulled in the upward and downward directions as the first connection device 510 and the second connection device 610 move away from each other in the upward and downward directions in the state in which the two opposite ends of the waist cable 250 are fixed to the first connection device 510 and the second connection device 610 (or the lower end of the leg length adjustment device 620). That is, the leg cable 650 is unfolded in the upward and downward directions as the upper end of the leg cable 650 moves upward based on the lower end of the leg cable 650 fixed to the second connection device 610.

A part of the leg cable 650, which is curved in a zigzag shape, is unfolded as the two opposite ends of the leg cable 650 are pulled in the upward and downward directions, such that the second slider 662 moves upward along the groove 6611, and the second spring 663 is stretched from the original state and generates a restoring force for pulling the second slider 662 downward. For example, the second slider 662 is positioned at the lower end of the groove 6611 when the left leg support device 300L is in the minimum length state, and the second slider 662 moves upward and is positioned at the upper end of the groove 6611 when the left leg support device 300L is in the maximum length state.

As the second slider 662 moves upward, a distance between the second slider 662 and the second spring post 631 is increased, and the second spring 663 is stretched. The second spring 663 may be stretched and generate a restoring force proportional to the stretched length, thereby providing a cause the tension to the leg cable 650. Therefore, it is possible to prevent the leg cable 650 from being twisted, bent, and disconnected when the length is adjusted.

On the contrary, when the first sub-link module 500L is pulled downward relative to the second sub-link module 600L (or the second sub-link module 600L is pulled upward relative to the first sub-link module 500L) when the left leg support device 300L is in the maximum length state, the leg length adjustment device 620 is retracted into the insertion device 520 of the first sub-link module 500L, such that the left leg support device 300L may switch to the minimum length state. In this case, as the second slider 662 is moved downward along the groove 6611 by a restoring force of the second spring 663, the leg cable 650 is pulled in the direction in which the two opposite ends of the leg cable 650 move toward each other. That is, the upper end of the leg cable 650 moves downward based on the lower end of the leg cable 650 fixed to the second connection device 610, such that a device of the leg cable 650, which has been unfolded as the second slider 662 has moved to the upper end of the leg cable 650, is curved again.

As illustrated in FIG. 19, as the leg length adjustment device 620 moves in the upward and downward directions relative to the first sub-link module 500L, a length of a second bending section 651 of the leg cable 650, which is bent based on the second movable roller 6623 and has portions facing each other in the leftward/rightward direction, is changed.

In this case, the second bending section 651 may be defined as a section of a device of the leg cable 650 bent based on the second movable roller 6623, the section extending upward from the second movable roller 6623 and extending from a third point P3, which overlaps the third fixing roller 664, to a fourth point P4 facing the third point P3 in the forward and backward directions F and B. For example, the third point P3 and the fourth point P4 may be positioned on the same line extending in parallel with the forward and backward directions F and B.

When the left leg support device 300L is in the minimum length state, the second slider 662 is positioned at the lower end of the groove 6611, and the second movable roller 6623 is spaced apart downward from the third fixing roller 664 at a maximum distance, such that the second bending section 651 may have a maximum length. On the contrary, when the left leg support device 300L is in the maximum length state, the second slider 662 is positioned at the upper end of the groove 6611, and the second movable roller 6623 is spaced apart downward from the third fixing roller 664 at a minimum distance, such that the second bending section 651 may have a minimum length.

When a length of the second bending section 651 in the minimum length state of the left leg support device 300L is referred to as a third length and a length of the second bending section 651 in the maximum length state of the left leg support device 300L is referred to as a fourth length shorter than the third length, a length by which the leg cable 650 moves between the minimum length state and the maximum length state may be a difference between the third length and the fourth length.

For example, the left leg support device 300L may be configured such that the third length is about 123 mm and the fourth length is about 39 mm. In this case, the leg cable 650 moves by about 84 mm to adjust the length of the left leg support device 300L. However, the above-mentioned numerical values are illustrative and do not limit the embodiment of the present disclosure.

The above description is simply given to illustratively describe the technical spirit of the present disclosure, and those skilled in the art to which the present disclosure pertains will appreciate that various changes and modifications are possible without departing from the essential characteristic of the present disclosure. Therefore, the embodiments disclosed in the present disclosure are provided for illustrative purposes only but are not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

What is claimed is:

1. A wearable robot comprising:
a waist support device configured to support a wearer's waist;
a left leg support device coupled to a left side of the waist support device and configured to be mounted on the wearer's left leg; and
a right leg support device coupled to a right side of the waist support device and configured to be mounted on the wearer's right leg,
wherein at least one of the waist support device, the left leg support device, or the right leg support device comprises a length adjustment device configured to adjust a length thereof,
wherein the length adjustment device comprises:
a body;
a cover coupled to the body;
a cable support device provided between the body and the cover; and
a cable having two opposite fixed ends and at least partially supported on the cable support device.

2. The wearable robot of claim 1, wherein the length adjustment device provided in the waist support device is a waist length adjustment device,
wherein the waist support device comprises:
a main body;
a left coupling module coupled to a left side of the main body, configured to be movable in leftward and rightward directions, and configured such that the left leg support device is coupled to the left coupling module; and
a right coupling module coupled to a right side of the main body, configured to be movable in the leftward and rightward directions, and configured such that the right leg support device is coupled to the right coupling module,
wherein the left coupling module and the right coupling module each comprise:
the waist length adjustment part; and
a coupling device connected to one side of the waist length adjustment device and configured such that the left leg support device and the right leg support device are coupled to the coupling device, and
wherein the waist length adjustment device has the other side movably coupled to the main body and is configured such that at least a device of the waist length adjustment device is extended from the main body or retracted into the main body to adjust a length of the waist support device.

3. The wearable robot of claim 2, wherein the waist support device is provided such that the left coupling module and the right coupling module are vertically symmetric with respect to the main body.

4. The wearable robot of claim 2, wherein the waist length adjustment device comprises:
a first body movably coupled to the main body;
a first cover coupled to a front side of the first body;
a first cable support device provided between the first body and the first cover; and
a waist cable supported by the first cable support device in a state in which two opposite ends of the waist cable are respectively fixed to the main body and the coupling device.

5. The wearable robot of claim 4, wherein the first cable support device comprises:
a first guide member coupled to the first body and having a groove extending in the leftward and rightward directions;
a first slider slidably coupled to the first guide member;
a first spring extending in the leftward and rightward directions and having one end coupled to the first body and the other end coupled to the first slider; and
a first fixing roller coupled to the first body, provided to be in contact with the waist cable, and configured to rotate in response to a movement of the waist cable.

6. The wearable robot of claim 5, wherein the first slider comprises:
a first flange portion disposed between the first guide member and the first body;
a first fixing protrusion extending from the first flange portion toward the first cover and having one side to which the first spring is coupled; and
a first movable roller rotatably coupled to the first flange portion and spaced apart from the other side of the first fixing protrusion.

7. The wearable robot of claim 5, wherein the first cover has a guide protrusion protruding from a surface facing the first body to form a groove corresponding to the groove of the first guide member.

8. The wearable robot of claim 5, wherein a first spring post, to which the first spring is fixed, is provided on the first body, and
wherein the first spring is configured to connect the first slider and the first spring post in the leftward and rightward directions and provide an elastic restoring force in response to a movement of the first slider relative to the first spring post.

9. The wearable robot of claim 6, wherein the waist cable is provided to extend from one end fixed to the main body to the other end fixed to the coupling device while traversing a space between the first movable roller and the first fixing protrusion.

10. The wearable robot of claim 9, wherein the waist cable extends from the main body toward the coupling device, is primarily bent toward the main body while surrounding the first movable roller, extends after being primarily bent, and is secondarily bent toward the coupling device while surrounding the first fixing roller.

11. The wearable robot of claim 2, wherein the left leg support device comprises:
a first left link module coupled to the left coupling module of the waist support part;
a second left link module rotatably coupled to a lower end of the first left link module; and
a third left link module rotatably coupled to a lower end of the second left link module, and
wherein the right leg support device comprises:
a first right link module coupled to the right coupling module of the waist support part;
a second right link module rotatably coupled to a lower end of the first right link module; and
a third right link module rotatably coupled to a lower end of the second right link module.

12. The wearable robot of claim 11, wherein the length adjustment device provided in each of the left leg support device and the right leg support device is a leg length adjustment device,
wherein the second left link module and the second right link module each comprise:
a first sub-link module having an upper end to which the first left link module and the first right link module are rotatably connected; and
a second sub-link module coupled to a lower end of the first sub-link module, and configured to be movable in upward and downward directions, and having a lower end to which the third left link module and the third right link module are rotatably connected, and
wherein the second sub-link module comprises the leg length adjustment device.

13. The wearable robot of claim 12, wherein the first sub-link module comprises:
a first connection device connected to the first left link module and the first right link module; and
an insertion device coupled to a lower end of the first connection device and configured such that the leg length adjustment device is inserted into the insertion device so as to be movable in the upward and downward directions, and
wherein the second sub-link module further comprises a second connection device coupled to a lower end of the leg length adjustment device and configured such that the third left link module and the third right link module are connected to the second connection device.

14. The wearable robot of claim 13, wherein the leg length adjustment device is configured to adjust a length of the second sub-link module while being extended from the insertion device or retracted into the insertion device.

15. The wearable robot of claim 13, wherein the leg length adjustment device comprises:
a second body movably coupled to the insertion part;
a second cover coupled to one side of the second body;
a second cable support device provided between the second body and the second cover; and
a leg cable supported by the second cable support device in a state in which two opposite ends of the leg cable are respectively fixed to the first connection device and the second connection device.

16. The wearable robot of claim 15, wherein the second cable support device comprises:
a second guide member coupled to the second body and having a groove extending in the upward and downward directions;
a second slider slidably coupled to the second guide member;
a second spring extending in the upward and downward directions and having a lower end coupled to the second body and an upper end coupled to the second slider; and
a third fixing roller coupled to the second body, provided to be in contact with the leg cable, and configured to rotate in response to a movement of the leg cable.

17. The wearable robot of claim 16, wherein the second slider comprises:
a second flange portion disposed between the second guide member and the second body;
a second fixing protrusion extending from the second flange portion toward the second cover and having a lower side to which the second spring is coupled; and
a second movable roller rotatably coupled to the second flange portion and spaced apart from an upper side of the second fixing protrusion.

18. The wearable robot of claim 16, wherein a second spring post, to which the second spring is fixed, is provided on the second body, and
wherein the second spring is configured to connect the second slider and the second spring post in the upward and downward directions and provide an elastic restoring force in response to a movement of the second slider relative to the second spring post.

19. The wearable robot of claim 17, wherein the leg cable is provided to extend from a lower end fixed to the second connection device to an upper end fixed to the first connection device while traversing a space between the second movable roller and the second fixing protrusion, and wherein the leg cable extends from the second connection device toward the first connection device, is primarily bent toward the second connection device while surrounding the third fixing roller, extends after being primarily bent, and is secondarily bent toward the first connection device while surrounding the second movable roller.

20. The wearable robot of claim 1,
wherein the cable support device comprises:
a guide member coupled to the body and having a groove;
a slider configured to slide along the groove of the guide member;
a spring having one end fixed to the body and the other end fixed to the slider; and
a plurality of fixing rollers rotatably coupled to the body and provided to be in contact with the cable.
